(19) United States
(12) Patent Application Publication
(10) Pub. No.: US 2003/0031247 A1
(43) Pub. Date: Feb. 13, 2003

(54) Data communication system

(76) Inventors: Toshihisa Takahashi, Ehime (JP); Akiyoshi Yamashita, Osaka (JP)

Correspondence Address: PARKHURST & WENDEL, L.L.P., 1421 PRINCE STREET, SUITE 210, ALEXANDRIA, VA, 22314-2805, US

(21) Appl. No.: 10/239,027

(22) PCT Filed: Mar. 28, 2001
(86) PCT No.: PCT/JP01/02602

(30) Foreign Application Priority Data
Apr. 3, 2000 (JP) 2000-100144

(51) Int. Cl. H04B 1/66

(52) U.S. Cl. 375/240

(57) ABSTRACT

To provide a data communication system in which a host computer is connected with a plurality of peripheral storage devices, which may carry out data transfer simultaneously without any substantial increase in data transfer time. A data transfer node includes a plurality of data compression means of different compression ratios, measuring means for measuring the effective data transfer rate of data transfer performed by the data transfer node over a communication channel, selection means for selecting one of the data compression means according to the effective data transfer rate obtained by the measuring means, and means for adding a data compression method to transferred data. A data receiving node includes means for decompressing received data by recognizing the compression method of the received data based on information about the compression method contained in the transferred data.

### TECHNICAL FIELD

The present invention relates to a data communication system and in particular to a system in which a plurality of electronic devices are interconnected over a time division multiplex data bus for performing data communication between them.

### BACKGROUND ART

When the amount of data transferred from a host computer to a peripheral storage device increases, a larger amount of time is required before the completion of the data transfer unless the host computer is connected with the peripheral storage device over a high-speed data bus.

To solve this problem, the data is compressed on the host computer or the peripheral storage device before transfer to reduce data transfer time.

However, when a plurality of peripheral storage devices connected with the host computer simultaneously transfer data, data transfer time slot allocated to each peripheral storage device decreases according to the number of storage devices connected over a time division multiplex data bus. As a result, time required for data transfer increases in proportion to the number of devices connected.

The present invention has been achieved in light of the current state of data transfer methods as described above. An object of the present invention is to provide a data communication system in which a host computer is connected with a plurality of peripheral storage devices, which may carry out data transfer simultaneously without substantial increases in data transfer time.

### DISCLOSURE OF INVENTION

To solve the above-described problem, a data communication system of the present invention in which a plurality of peripheral devices share a time division multiplex data bus selects and operates optimum compression means from among a plurality of compression means providing different amounts of compression time and compression efficiencies, according to the effective data transfer rate per peripheral device which decreases as the number of peripheral devices using simultaneously the data bus increases.

A data communication system of a first aspect of the present invention is a data communication system in which a plurality of nodes share a communication channel in a time division multiplex manner, and each of the nodes transfers data to another node, characterized in that a data transfer node comprises: a plurality of data compression means of different compression ratios; effective data transfer rate measuring means for measuring the effective data transfer rate of data transfer performed by the data transfer node over the communication channel; data compression method selection means for selecting one of the data compression means according to the effective data transfer rate obtained by the effective data transfer rate measuring means; and data compression method adding means for adding information about the data compression method to transfer data, and that a data receiving node comprises: data decompression means for decompressing the data by identifying the data compression method of the received transfer data based on information about the data compression method in said transfer data.

The data transfer node compares the measured effective data transfer rate with a predetermined criterion and, if the effective data transfer rate is higher, selects a data compression method that provides a low data compression ratio but can generate a large amount of compressed data to prevent the data transfer rate from being lowered. If the effective data transfer rate is lower, it selects a data compression method that generate a small amount of compressed data but provides a high compression ratio. The data transfer node adds data identifying the data compression method to the transfer data because the data receiving node should decompress the compressed transfer data by using a decompression method corresponding to the compression method.

The data communication system is also characterized in that the effective data transfer rate measuring means measures at regular intervals the effective data transfer rate of data transfer performed over the communication channel and changes the data compression method at regular intervals according to the effective data transfer rate obtained as the result of the measurement.

If the effective data transfer rate changes, an optimum compression method can be selected according to the change.

The data communication system is also characterized in that the data receiving node includes: a plurality of data decompression means supporting data compressed by the plurality of data compression means of the data transfer node; and data decompression method selection means for selecting the data decompression method based on the data compression method added to the data transferred from the data transfer node.

The data receiving node can correctly select a decompression method for decompressing the data transferred from the data transfer node based on the data compression method added to the data.

A data communication system in a second aspect of the present invention is a data communication system in which a plurality of nodes share a communication channel in a time division multiplex manner, and each node transfers data to another node, characterized in that a data transfer node comprises: data compression means for providing a data compression ratio according to the number of repetitions of data compression; effective data transfer rate measuring means for measuring the effective data transfer rate of data transfer performed by the data transfer node over the communication channel; data compression repeating means for operating the data compression means for a plurality of times according to the effective data transfer rate obtained by the effective data transfer rate measuring means; and data compression repetition count adding means for adding the number of repetitions of data compression to transfer data; and a data receiving node comprises: data decompression repetition means for repeatedly performing data decompression based on the number of repetitions of data compression added to the data transferred from the data transfer node.

The data communication system is also characterized in that the effective data transfer rate measuring means is arranged so as to measure at regular intervals the effective data transfer rate of data transfer performed over the communication channel and change the number of repetitions of data compression at regular intervals according to the effective data transfer rate obtained as the result of the measurement.

The data communication system is also characterized in that the data receiving node includes: data decompression means supporting data compressed by the data compression means of the data transfer node; and data decompression repeating means for repeatedly performing the data decompression means based on the number of repetitions of data compressions added to the data transferred from the data transfer node.

The data communication system is also characterized in that data compression is not performed if the effective data transfer rate obtained by the effective data transfer rate measuring means is higher than a predetermined criterion.

If the data transfer rate will be lowered by data compression, the data compression is not performed to prevent the data transfer rate from being lowered.

The data communication system is also characterized in that the communication channel comprises a USB (Universal Serial Bus).

It is also characterized in that the communication bus is an IEEE 1394 serial bus.

It is also characterized in that the node is applied to a host computer.

It is also characterized in that the node comprises an information recording and reproduction device such as a hard disk drive, CD-ROM drive, and floppy disk drive.

It is also characterized in that the node comprises a video recording and reproduction device such as a digital video camera and digital video recorder.

As described above, a data communication system of the present invention in which a plurality of peripheral devices share a time division multiplex data bus selects and operates optimum compression means from among a plurality of compression means providing different amounts of compression time and compression efficiencies, according to the effective data transfer rate per peripheral device which decreases as the number of peripheral devices using simultaneously the data bus increases. As a result, increase in data transfer time can be minimized even if the peripheral storage devices simultaneously transfer data.

### BRIEF DESCRIPTION OF DRAWINGS

FIG. 1 is an explanatory diagram showing a general configuration of one embodiment of the present invention;

FIG. 2 is a block diagram showing a configuration of an external storage device of the embodiment;

FIG. 3 is a block diagram showing a configuration of a data transfer controller provided in a host computer of the embodiment;

FIG. 4 is a state transition diagram showing data transfer on a bus while one external storage device of the embodiment is transferring data;

FIG. 5 is a state transition diagram showing data transfer on the bus while five external storage devices of the embodiment are transferring data;

FIG. 6 shows a configuration of transfer data of the embodiment;

FIG. 7 is a characteristic comparison diagram of data compression methods of the embodiment;

FIG. 8 is a flowchart of a data compression process of the embodiment;

FIG. 9 is a characteristic comparison diagram showing an effect of the embodiment;

FIG. 10 is a characteristic comparison diagram of repetitions of data compression; and

FIG. 11 is a flowchart of a data compression process of the embodiment.

### BEST MODE FOR CARRYING OUT THE INVENTION

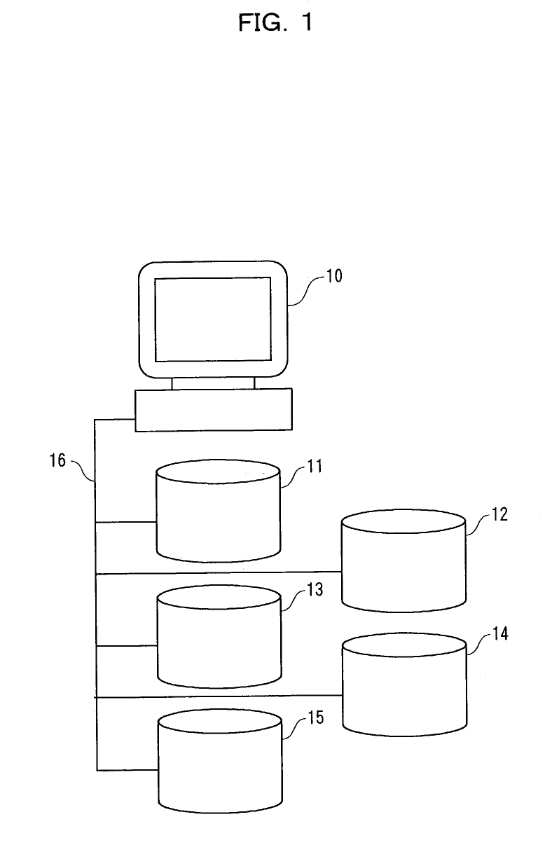

Embodiments of the present invention will be described below with respect to FIGS. 1 through 11.

FIG. 1 shows a data communication system according to the present invention.

Five external storage devices 11 through 15 are connected to the host computer 10 over a USB (Universal Serial Bus) 16. The host computer 10 is configured so as to be able to send/receive data to/from the external storage devices 11 through 15.

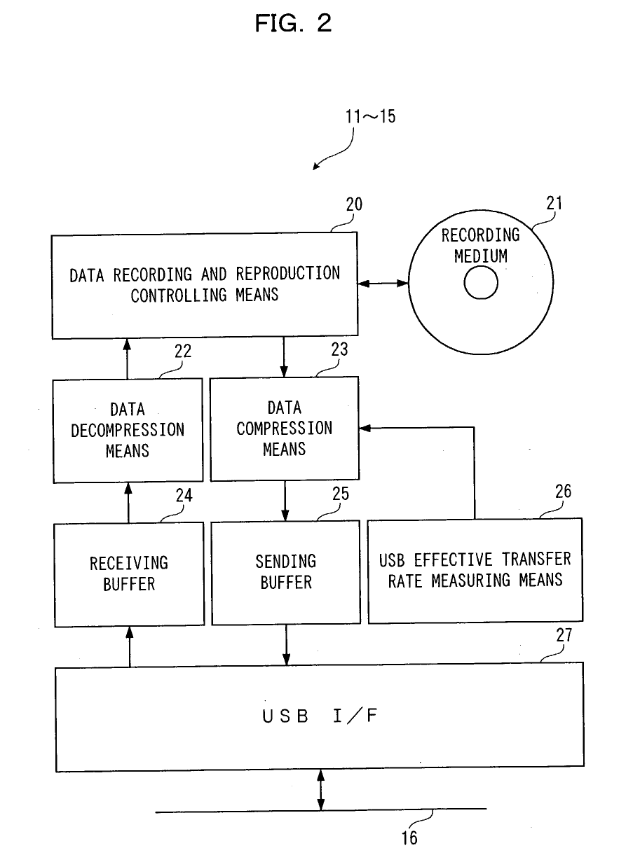

FIG. 2 shows an internal configuration of the external storage devices 11 through 15.

When data recorded on a recording medium 21 is transferred from a USB I/F 27 to the host computer 10, a data recording and reproduction control means 20 reads data from the recording medium 21 and transfers it to data compression means 23.

The data compression means 23 compresses the data and then transfers the compressed data to a sending buffer 25.

Then, the USB I/F 27 reads the data from the sending buffer 25 at each data transfer timing for a USB 16 and sends the data to the host computer 10 over the USB 16.

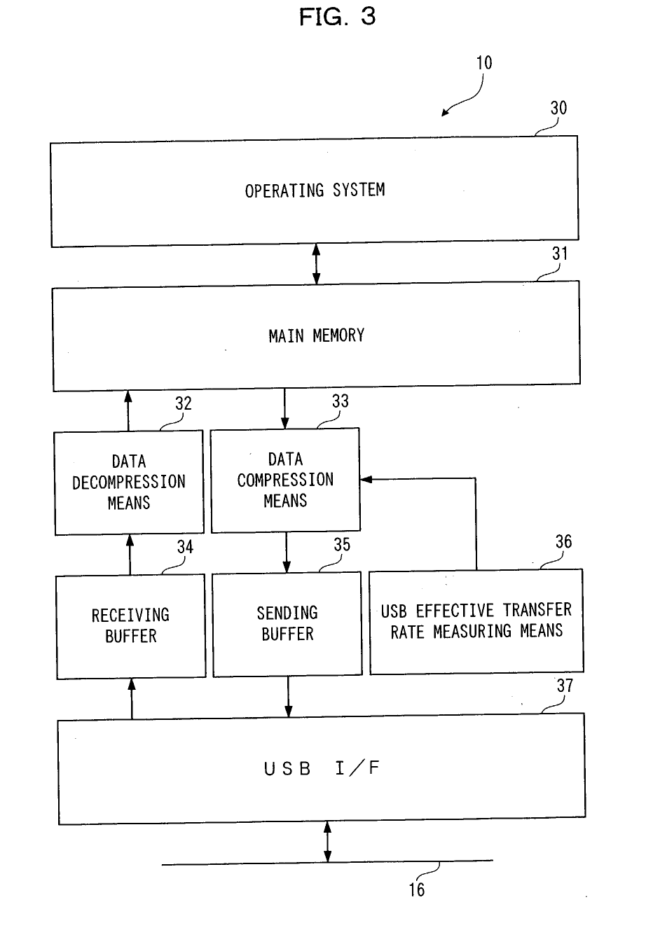

FIG. 3 shows an internal configuration of the host computer 10.

When data is received from the external storage devices 11 through 15, the USB. I/F37 first receives the data. The received data is stored in a receiving buffer 34, then decompressed by a data decompression means 32 and transferred to a main memory 31.

Data compression performed in the data compression means 23 shown in FIG. 2 will be described below.

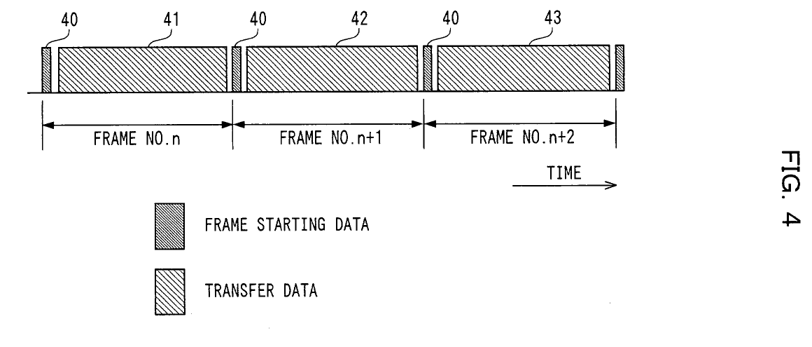

FIG. 4. shows data transfer on the data bus when one of the external storage devices 11 through. 15 transfers data. Only frame starting data 40 and transfer data 41 through 43, transferred from the external storage device are contained in a frame, which is a unit of data transfer over the USB.

The data compression is performed on transfer data 42, which will be transferred in the next frame, while transfer data 41 is being transferred. The data compression requires throughput of generating an amount of compressed data that is required for the next data transfer within a time period in which one frame is transferred.

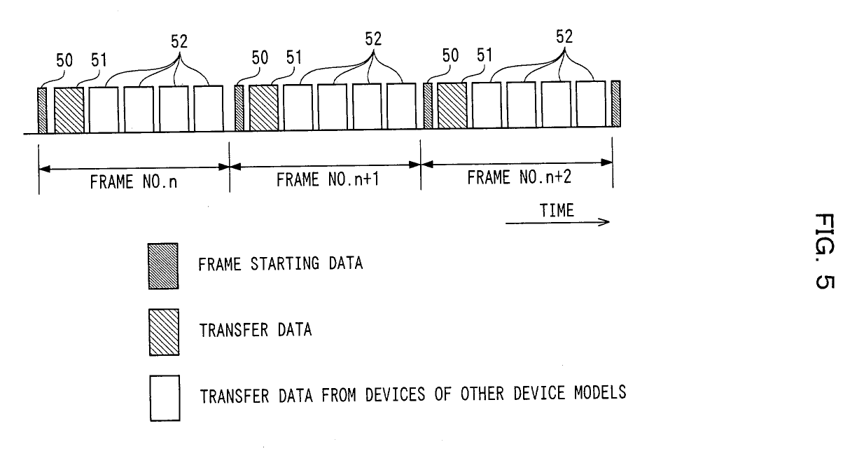

If data is transferred from all of the five external storage devices, the data bus is time-divided among the five external storage devices as shown in FIG. 5. Noting data transfer from a particular one device, the amount of transfer data 51 from the device is 20% of the transfer data 41 during data transfer performed by only one device as shown in FIG. 4 under the influence of the transfer data 52 of other devices.

This means that the amount of compressed data that must be generated by compression is 20% of that during the transfer performed by only one device.

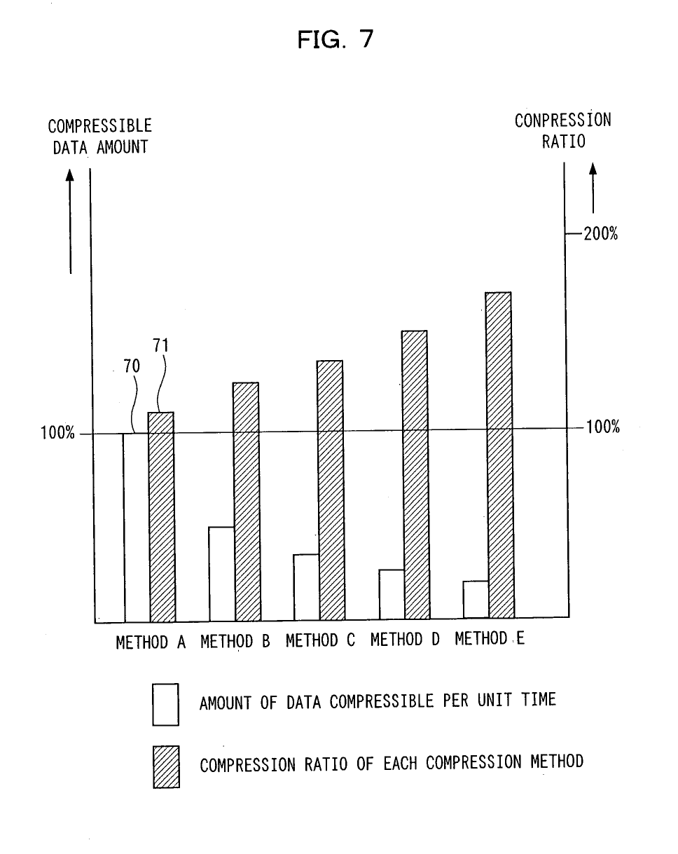

FIG. 7 shows a characteristic diagram showing the characteristics of a plurality of compression methods provided by the data compression means 23. The data amount 70 that can be compressed per unit of time by method A is represented as 100%. Method A provides the largest amount of data that can be compressed per unit of time, followed by methods B, C, D, and E, in that order.

Compression ratios are calculated by

Compression ratio=(amount of data before compression)/(amount of data after compression).

The higher the compression ratio, the higher the compression efficiency. Method A provides the lowest compression ratio. Methods B, C, D, and E, in increasing order, provide higher compression ratios.

That is, compression method A provides a lower compression ratio but can generate a larger amount of compressed data per unit of time. In contrast, method E provides a higher compression ratio but generates smaller amount of compressed data.

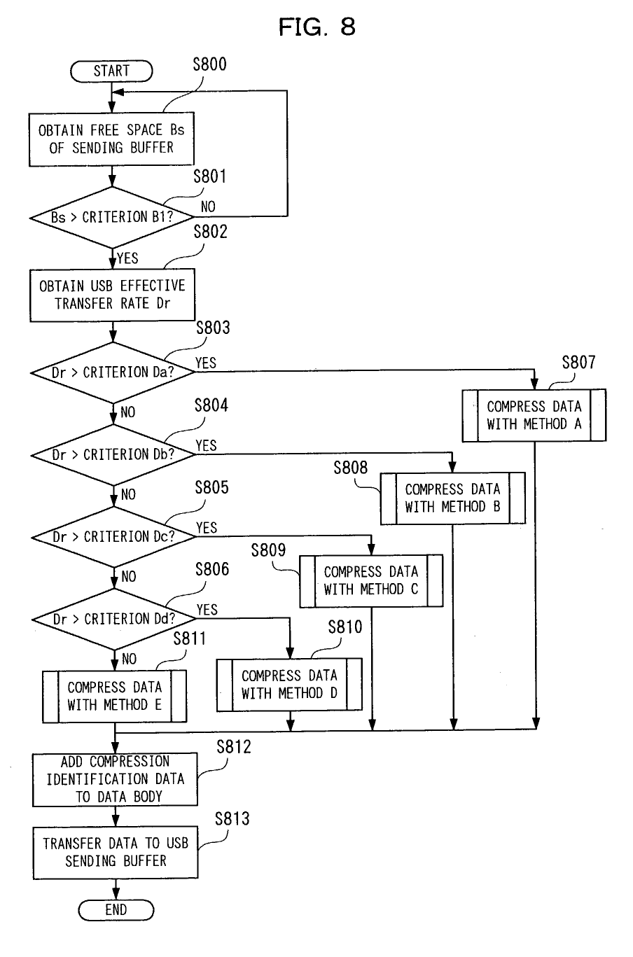

A flowchart in FIG. 8 shows a process performed in the data compression means 23 for selecting one of the above-mentioned compression methods.

At step S800, free space Bs of sending buffer 25 is obtained.

At step 801, the free space Bs obtained is compared with a criterion B1 to determine whether compression should be performed or not.

If it is determined at step 801 that the free space Bs is smaller than the criterion B1, the process returns to step S800 and waits until the free space BS of the sending buffer 25 becomes larger than the criterion B1 by repeating step 801 and step S800.

If it is determined at step 801 that the free space Bs is larger than the criterion B1, step S802 is performed.

At step S802, the effective transfer rate Dr of the USB is obtained from USB effective transfer rate measuring means 26. Then, the USB effective transfer rate Dr is compared with a criterion Da at step S803.

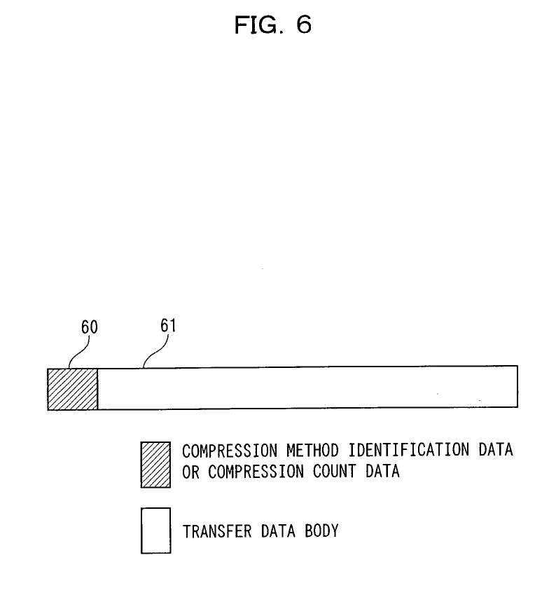

If it is determined at step S803 that Dr is larger, data compression is performed by using compression method A at step S807. Compression method identification data 60 is prepended to the compressed data body 61 as shown in FIG. 6 at step S812.

On the other hand, if it is determined at step S803 that Dr is smaller, steps S804 through S806 are performed. Criteria at steps S804 through S806 are Db through Dd, respectively. Similarly to step S803, one of compression methods at steps S808 through S811 is selected and performed based on the USB effective transfer rate Dr obtained at step S802 in order to perform step S812.

Then, the compressed data is transferred to the sending buffer 25 at step S813.

Thereafter, the data transferred from the I/F 27 to the host computer 10 over the USB 16 is decompressed in data decompression means 32 by using data decompression means selected based on the compression method identification data 60 added during data compression.

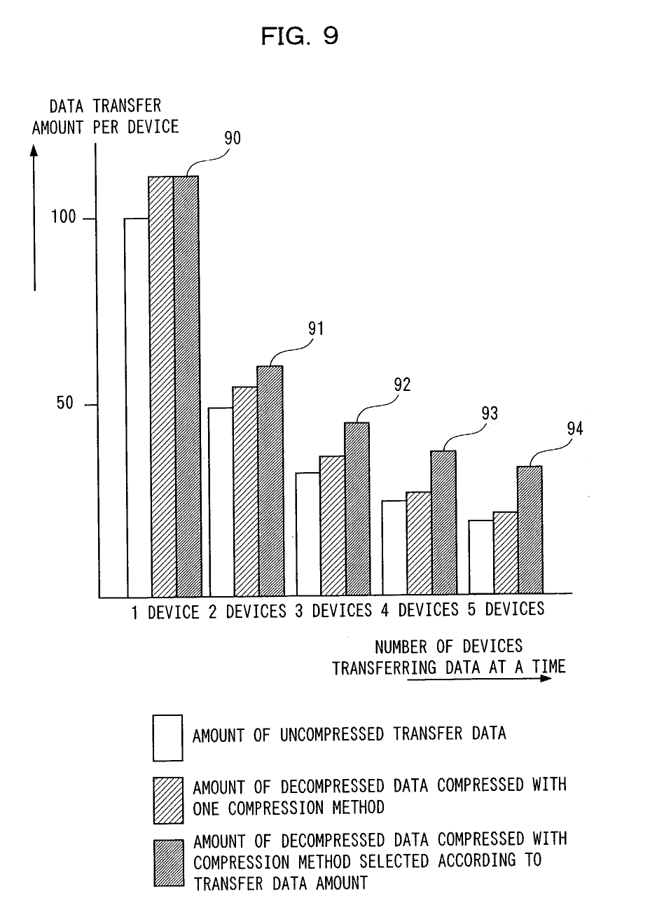

FIG. 9 shows a data transfer amount per device in a case where data compression method is selected according to the effective transfer rate of the USB. The amount of uncompressed data transferred when only one device performs data transfer is represented as 100%.

Decompressed data amount 90 results in the case when the number of devices transferring data at a time over the USB is one and compression method A is selected. Decompressed data amount 91 results in the case when the number of devices transferring data at a time over the USB is two and compression method B is selected. Similarly, decompressed data amount 92, 93, and 94 result in the case when compression method C, D, and E, respectively, are selected.

Thus, each of the external storage devices 11 through 15 connected onto the USB can minimize decrease in amount of transfer data by detecting the effective transfer rate of the USB and selecting a compression method from among the compression methods A through E for each of transfer rates even if the number of devices that use the USB at a time increases.

While one of data compression methods A through E is selected according to the transfer rate of the USB in the example described above, uncompressed data may be transferred without selecting any data compression means according to the transfer rate of the USB, depending on the throughput of the data compression means 23 or data decompression means 32.

The example has been described in which the external storage devices 11 through 15 transfer data to the host computer 10, data can be transferred from the host computer 10 to the external storage devices 11 through 15 in a similar manner.

While one of data compression method A through E is selected according to the transfer rate of the USB in the example described above, similar results can be obtained by repeatedly performing the same data compression method according to the transfer rate of the USB and the data is decompressed by repeatedly performing the same data decompression method.

In particular, in a data communication system in which a plurality of nodes share a communication channel in time division multiplex mode, each of the nodes transferring data to another node, a data transfer node comprises data compression means for providing a data compression ratio according to the number of repetitions of data compression; effective data transfer rate measuring means for measuring the effective data transfer rate of data transfer performed by the data transfer node over a communication channel; data compression repeating means for operating data compression means more than once according to the effective data transfer rate obtained by the effective data transfer rate measuring means; and data compression repetition count adding means for adding a data compression repetition count to transfer data.

The data transfer node compares the measured effective data transfer rate with a criterion and, if the effective data transfer rate is higher, decreases the number of repetitions of compression so that the compression ratio decreases but the amount of compressed data that can be generated increases, thereby preventing the data transfer rate from being lowered. On the other hand, if the effective data transfer rate is lower the data transfer node increases the number of repetitions of data compression so that the amount of compressed data that can be generated decreases but a higher compression ratio can be obtained. The data transfer node, in decompressing the compressed transfer data, adds data indicating the number of repetitions of compression to the transfer data because a data receiving node should perform a number of repetitions of decompression that corresponds to the number of repetitions of compression. The effective data transfer rate measuring means in this embodiment performs measurement at regular intervals and changes at regular intervals the number of repetitions of data compression according to an effective data transfer rate obtained as the result of the measurement. At this time, in the case where the effective data transfer rate changes, it is possible to follow this change and select an optimum number of repetitions of compression. The data receiving node in this embodiment comprises data decompression means supporting data provided to the data transfer node and compressed by the data compression means or the data transfer node, and data decompression repeating means for repeatedly performing the data decompression means based on the data compression repetition count added by the data transfer node. The data receiving node can correctly determine the number repetitions of decompression for decompressing data sent from the transfer node based on the data compression counts added to the data.

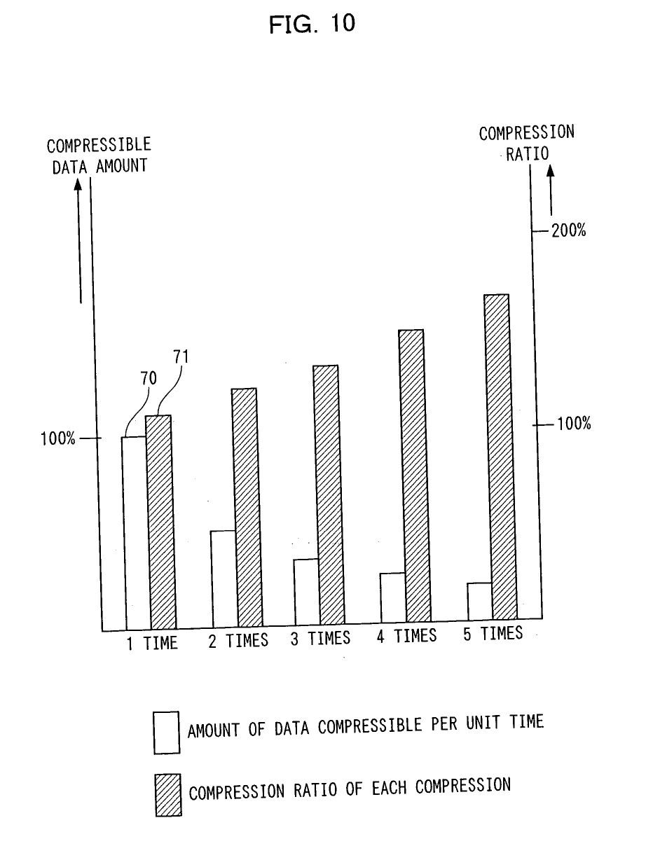

FIG. 10 shows a characteristic comparison diagram of repetitions of data compression in this embodiment.

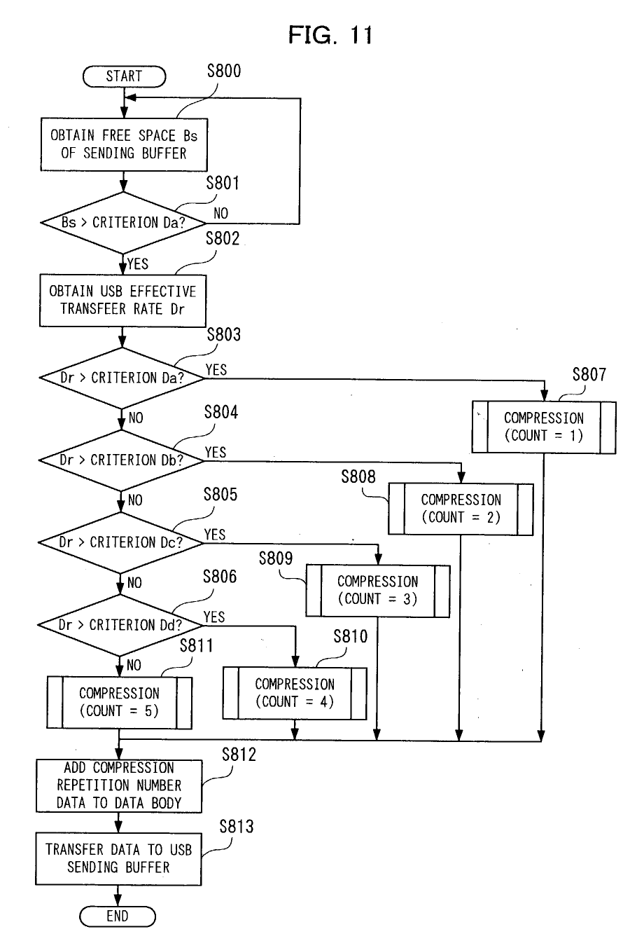

FIG. 11 shows a flowchart of a data compression process.

Again, this embodiment is arranged so as not to perform data compression if the effective data transfer rate obtained by the effective data transfer rate measuring means is higher than a predetermined criterion. This arrangement prevents data compression from being performed if the data compression will decrease the data transfer rate, thereby preventing the data transfer rate from being lowered.

While the embodiments has been described by using a USB as an example of the communication channel, similar effects can be obtained by using an IEEE 1394 serial bus as the communication channel.

While the embodiments has been described with respect to a host computer and external storage devices by way of example of the data transfer node or receiving node, similar effects can be obtained by using information recording and reproduction devices such as a digital video camera and digital video recorder or the like.

1. A data communication system, in which a plurality of nodes share a communication channel in a time division multiplex manner, each node transferring data to another node, wherein
a data transfer node comprises:
a plurality of data compression means of different compression ratios;
effective data transfer rate measuring means for measuring the effective data transfer rate of data transfer performed by the data transfer node over the communication channel;
data compression method selection means for selecting one of said data compression means according to the effective data transfer rate obtained by said effective data transfer rate measuring means; and
data compression method adding means for adding information about said data compression method to transfer data, and
a data receiving node comprises:
data decompression means for decompressing the data by identifying the data compression method of the received transfer data based on the information about said data compression method in said transfer data.

2. The data communication method according to claim 1, wherein said effective data transfer rate measuring means measures at regular intervals the effective data transfer rate of data transfer performed over the communication channel and changes said data compression method at regular intervals according to the effective data transfer rate obtained as the result of the measurement.

3. The data communication system according to claim 1, wherein said data receiving node comprises:
a plurality of data decompression means supporting data compressed by the plurality of data compression means of said data transfer node; and
data decompression method selection means for selecting said data decompression method based on the data compression method added to the data transferred from said data transfer node.

4. A data communication system, in which a plurality of nodes share a communication channel in a time division multiplex manner, each node transferring data to another node, wherein
a data transfer node comprises:
data compression means for providing a data compression ratio according to the number of repetitions of data compression;
effective data transfer rate measuring means for measuring the effective data transfer rate of data transfer performed by said data transfer node over said communication channel;
data compression repeating means for operating said data compression means for a plurality of times according to the effective data transfer rate obtained by said effective data transfer rate measuring means; and
data compression repetition count adding means for adding said number of repetitions of data compression to transfer data, and
a data receiving node comprises:
data decompression repetition means for repeatedly performing data decompression based on the number of repetitions of data compression added to the data transferred from the data transfer node.

5. The data communication system according to claim 4, wherein said effective data transfer rate measuring means (26, 36) measures at regular intervals the effective data transfer rate of data transfer performed over the communication channel, and changes the number of repetitions of data compression at regular intervals according to the effective data transfer rate obtained as the result of the measurement.

6. The data communication system according to claim 4, wherein said data receiving node comprises:
data decompression means supporting data compressed by the data compression means of said data transfer node; and
data decompression repeating means for repeatedly operating said data decompression means based on the number of repetitions of data compressions added to the data transferred from said data transfer node.

7. The data communication system according to any of claims 1 to 6, wherein data compression is not performed if the effective data transfer rate obtained by said effective data transfer rate measuring means is higher than a predetermined criterion.

8. The data communication system according to any of claims 1 to 7, wherein said communication channel comprises a USB (Universal Serial Bus).

9. The data communication system according to any of claims 1 to 7, wherein said communication channel comprises an IEEE 1394 serial bus.

10. The data communication system according to any of claims 1 to 7, wherein said node comprises a host computer.

11. The data communication system according to any of claims 1 to 7, wherein said node comprises an information recording and reproduction device.

12. The data communication system according to any of claims 1 to 7, wherein said node comprises a video recording and reproduction device.
